(19) United States
(12) Patent Application Publication
(10) Pub. No.: US 2020/0125671 A1
(43) Pub. Date: Apr. 23, 2020

(54) ALTERING CONTENT BASED ON MACHINE-LEARNED TOPICS OF INTEREST

(71) Applicant: International Business Machines Corporation, Armonk, NY (US)

(72) Inventors: Qi Li, BEIJING (CN); Jin Sheng Gao, Beijing (CN); Zhi Li, Beijing (CN); Bo Tong Liu, BEIJING (CN); Jonathan Dunne, County Waterford (IE)

(21) Appl. No.: 16/162,716

(22) Filed: Oct. 17, 2018

(51) Int. Cl. G06F 17/30; G06F 3/01; G06F 17/27; G06N 3/04

(52) U.S. Cl. CPC G06F 17/30616; G06F 17/30716; G06N 3/04; G06F 17/27; G06F 3/013

(57) ABSTRACT

A method, system, and computer program product are provided. Content portions of respective items of multiple items of textual content are tagged according to determined topics, keywords and phrases. Data is collected regarding viewed regions of a display screen displaying at least a portion of the respective item. A model is derived for predicting portions of textual content of interest based on the collected data regarding the viewed regions of the display screen and the tagging. A new item of textual content is altered to provide portions of interest based on the model.

### BACKGROUND

### 1. Technical Field

Present invention embodiments relate to systems, methods and computer program products for machine learning of topics of interest based on read textual content to produce a model, predicting which paragraphs of new textual content include a topic of interest and would be read by a user, and displaying an altered version of the new textual content, wherein the altered version of the new textual content is altered based on the model.

### 2. Discussion of the Related Art

Currently, much information is shared via social media. When users visit websites, Wikis and social media platforms they may only wish to focus their attention on topics in which they are interested instead of having to skim through presented textual content for paragraphs regarding those topics of interest. Thus, much of users' valuable time may be consumed by skimming the textual content for those portions of the textual content which are of interest to the users.

### SUMMARY

According to one embodiment of the present invention, a computer-implemented method is provided for altering textual content based on machine learned topics. Content portions of respective items of multiple items of textual content are tagged according to determined topics, keywords and phrases. Data is collected regarding viewed regions of a display screen displaying at least a portion of each respective item of textual content. Based on the collected data regarding the viewed regions of the display screen and the tagging, a model for predicting portions of textual content of interest is derived. A new item of textual content is altered to provide portions of interest based on the model.

According to a second embodiment of the present invention, a system for altering textual content based on machine learned topics is provided. The system includes at least one processor and one or more memories connected to each of the at least one processor. The at least one processor is configured to tag each content portion of respective items of multiple items of textual content according to determined topics, keywords and phrases. Data regarding viewed regions of a display screen displaying at least a portion of the each respective item is collected. A model for predicting portions of textual content of interest based on the collected data regarding the viewed regions of the display screen and the tagging is derived. A new item of textual content is altered to provide portions of interest based on the model.

According to a third embodiment of the present invention, a computer program product is provided. The computer program product includes at least one computer readable storage medium having computer readable program code embodied therewith for execution on at least one processor of a computer device. The computer readable program code is configured to be executed by the at least one processor to perform a number of steps. According to the steps, content portions of respective items of multiple items of textual content are tagged according to determined topics, keywords and phrases. Data are collected regarding viewed regions of a display screen displaying at least a portion of the each of the respective items. A model is derived for predicting portions of textual content of interest based on the collected data regarding the viewed regions of the display screen and the tagging. A new item of textual content is altered to provide portions of interest based on the model.

### BRIEF DESCRIPTION OF THE DRAWINGS

Generally, like reference numerals in the various figures are utilized to designate like components.

FIG. 1 shows an example operating environment in which various embodiments of the invention may be implemented.

FIG. 2 illustrates an example computer system for implementing a server or a client device according to embodiments of the invention.

FIG. 3 illustrates example processing in various embodiments to tag paragraphs of textual content according to determined topics, keywords and phrases regarding the paragraphs.

FIG. 4 illustrates processing of inputs provided to a deep learning system for deriving a model according to embodiments of the invention.

FIG. 5 is a flowchart illustrating example processing for determining topics of portions of textual content, capturing eye gazes and eye gaze duration information regarding displayed portions of textual content and deriving a model for predicting portions of textual content of interest.

FIG. 6 is a flowchart illustrating example processing of a new item of textual content based on the model.

FIG. 7 is a block diagram illustrating components of a system and interactions among the components according to some embodiments of the invention.

### DETAILED DESCRIPTION

Present invention embodiments create a model such as, for example, a social interest model (SIM), based on textual content and eye gaze information. The textual content may include textual content from a social Wiki, blog, a social media platform, or other source.

When collecting information for creating the model, textual content may be displayed to a user via a display of a computer device. The computer device may include an image capturing device such as, for example, a camera, integrated therein or connected to the computer device such that the camera may be arranged to capture eye gazes of a user's eyes while the user is viewing the displayed textual content. The computer device may derive eye gaze information corresponding to displayed paragraphs or other portions of the textual content based on regions of the display to which eyes of the user gaze as well as a corresponding duration of time for each gaze.

Paragraphs of the textual content may be topic modeled to determine a most important topic of each paragraph. The computer device may perform natural language processing on each paragraph of the textual content. The natural language processing may include lexical analysis, syntactic analysis, semantic analysis and pragmatic analysis.

One method for topic modelling each paragraph may include latent Dirichlet allocation (LDA), which is a known generative probabilistic model for collections of discrete data such as documents of textual content made up of words and/or phrases (n-grams). Another known method that may be used for topic modelling may include biterm topic modelling (BTM), which is based on modelling word co-occurrence patterns. Other embodiments may perform topic modelling based on other methods. As a result of the topic modelling of the paragraphs of the textual content, each of the paragraphs may be tagged and each of the tags may include topic information including one or more keywords and/or phrases.

After collecting eye gaze information and generating tags for a number of items of textual content, a model such as, for example, a Social Interest Model (SIM) may be generated. In some embodiments, the model may be implemented as a neural network model.

Once the model is created, paragraphs of a newly obtained item of textual content can be searched for specific keywords and/or phrases, and based on the model, a topic of each paragraph may be predicted and the paragraphs may be predicted as being read and unread. An altered version of the textual content may be displayed. In some embodiments, paragraphs that are predicted to be unread, based on the model, may be removed from the textual content to be displayed. In other embodiments, the textual content to be displayed may be refactored such that predicted read paragraphs may be displayed before predicted unread paragraphs. In some embodiments, the model may predict a location on a display a user is most likely to look and may refactor the displayed textual content such that paragraphs of interest may be displayed at the locations of the display that are predicted to be the locations where the user is most likely to look.

In some embodiments, the natural language processing may determine specific portions of textual content based on headers included in the textual content such as, for example, abstract, introduction, conclusion, etc. The specific portions may be tagged in at least some embodiments. Specific portions of interest may be determined based on collected eye gaze information. For example, specific portions of interest, as well as paragraphs of interest may be those specific portions and paragraphs that correspond to regions of a display screen at which a user gazes for at least a minimum threshold of time such as, for example, 30 seconds, one minute, or another time period.

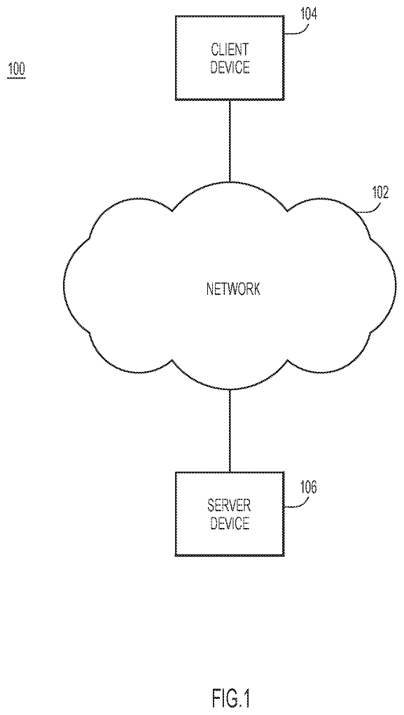

An example environment 100 for use with present invention embodiments is illustrated in FIG. 1. Specifically, environment 100 may include a client device 104, a network 102 and a server 106. Client device 104 and server 106 may be remote from each other and may communicate over network 102. Network 102 may be implemented by any number of any suitable communications media such as wide area network (WAN), local area network (LAN), Internet, Intranet, etc. Alternatively, client device 104 and server 106 may be local to each other, and may communicate via any appropriate local communication medium such as local area network (LAN), hardwire, wireless link, Intranet, etc. Server 106 may be a single computing device or a server farm including multiple computing devices.

Embodiments of the invention may be implemented on client device 104, server 106, or a combination of client device 104 and server 106. In some embodiments, a mapping model between a topic and a user's interest may be bound to a database, such as, for example, a relational database. Areas of interest and non-interest may be written to respective specific database tables, based on a user ID, and textual content may be refactored based on database join operations.

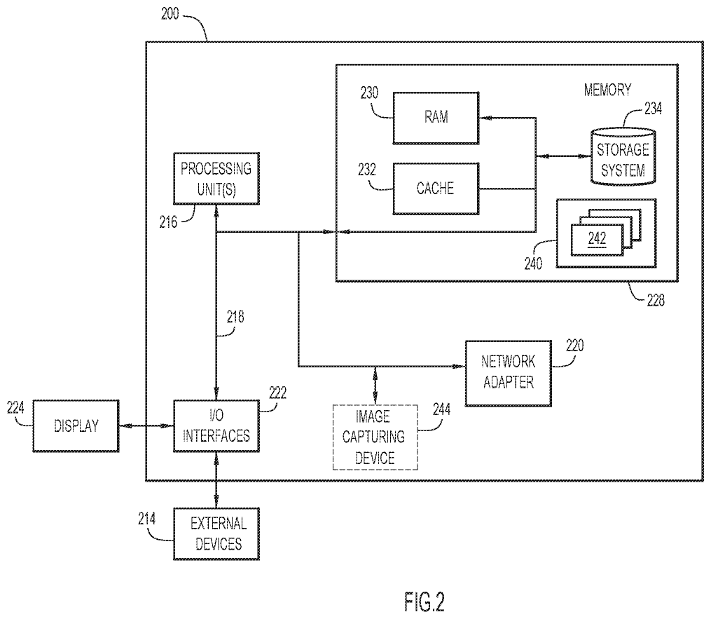

Referring now to FIG. 2, a schematic of an example computer system 200 is shown, which may implement client device 104 or server 106 in various embodiments. Computer system 200 is shown in a form of a general-purpose computing device. Components of computer system 200 may include, but are not limited to, one or more processors or processing units 216, a system memory 228, and a bus 218 that couples various system components including system memory 228 to one or more processing units 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 200 may include a variety of computer system readable media. Such media may be any available media that is accessible by computer system 200, and may include both volatile and non-volatile media, removable and non-removable media.

System memory 228 can include computer system readable media in the form of volatile memory, such as random access memory (RAM) 230 and/or cache memory 232. Computer system 200 may further include other removable/non-removable, volatile/non-volatile computer system storage media. By way of example only, storage system 234 can be provided for reading from and writing to a non-removable, non-volatile magnetic medium (not shown, which may include a “hard drive” or a Secure Digital (SD) card). Although not shown, a magnetic disk drive for reading from and writing to a removable, non-volatile magnetic disk such as, for example, a “floppy disk”, and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having at least one program module that is configured to carry out the functions of embodiments of the invention.

Program/utility 240, having a set (at least one) of program modules 242, may be stored in memory 228 by way of example, and not limitation, as well as an operating system, one or more application programs, other program modules, and program data. Each of the operating system, the one or more application programs, the other program modules, and the program data or some combination thereof, may include an implementation of a networking environment. Program modules 242 generally carry out the functions and/or methodologies of embodiments of the invention as described herein.

Computer system 200 may also communicate with one or more external devices 214 such as a keyboard, a pointing device, one or more displays 224, one or more devices that enable a user to interact with computer system 200, and/or any devices such as a network card, modem, etc. that enable computer system 200 to communicate with one or more other computing devices. Such communication can occur via Input/Output (I/O) interfaces 222. Still yet, computer system 200 can communicate with one or more networks such as a local area network (LAN), a general wide area network (WAN), and/or a public network such as, for example, the Internet, via network adapter 220. As depicted, network adapter 220 communicates with the other components of computer system 200 via bus 218. When computer system 200 implements client device 104, computer system 200 may include an image capturing device 244 such as, for example, a camera, for capturing eye gaze images of a user's eyes looking at a display screen while the screen displays textual content. Image processing may be performed on the captured images to determine regions of the display screen viewed by the user. It should be understood that, although not shown, other hardware and/or software components could be used in conjunction with computer system 200. Examples, include, but are not limited to: a microphone, one or more speakers, microcode, device drivers, redundant processing units, external disk drive arrays, RAID systems, tape drives, and data archival storage systems, etc.

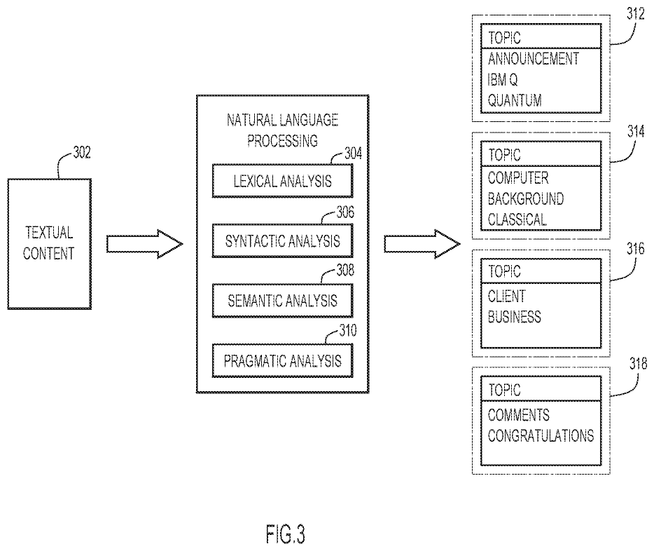

FIG. 3 illustrates processing of textual content when collecting information to be used for creating a model. Client device 104 may obtain textual content 302 and may perform natural language processing on each paragraph or other portions or units of textual content 302. The natural language processing may include lexical analysis 304, syntactic analysis 306, semantic analysis 308 and pragmatic analysis 310 in some embodiments. Lexical analysis 304 converts a sequence of characters into a sequence of tokens having an assigned meaning. Syntactic analysis 306 analyzes a sentence or other string of words into its constituent parts, resulting in a parse tree showing their syntactic relation to each other. Semantic analysis 308 looks at frequency, proximity and other factors regarding sequences of words to learn meanings of words and their relationships with other words. Pragmatic analysis 310 analyzes structured sets of text and extracts meaning. Further, topic modelling may be performed in various embodiments. For example, topic modelling may be performed by LDA, BTM or another method. As a result of the topic modelling, each paragraph may be tagged and may include a respective most important topic as well as respective keywords and/or phrases related to the most important topic of the paragraph. In FIG. 3, tags 312-318 are associated with each of four paragraphs of textual content 302.

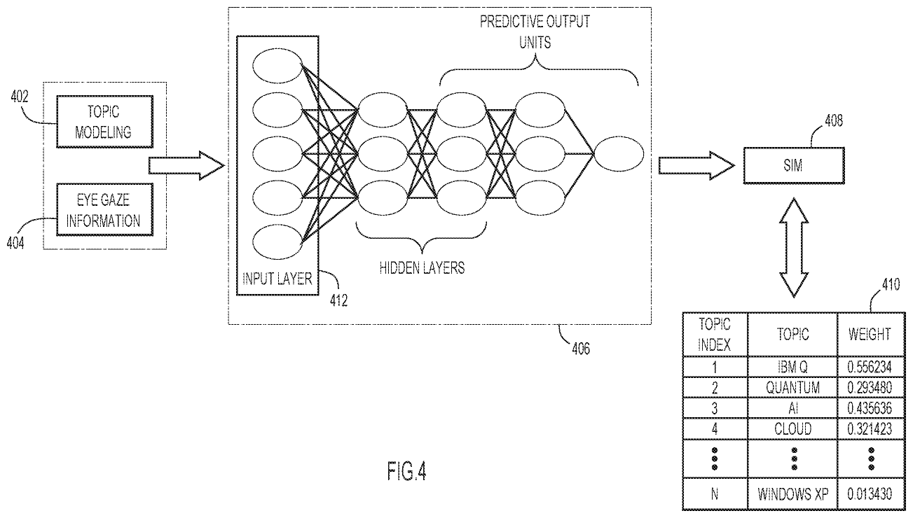

As shown in FIG. 4, tags of each paragraph of items of textual content, produced as a result of topic modelling 402 and corresponding eye gaze information 404, indicating which paragraphs a user's eyes gazed upon and corresponding durations of the gazes may be provided to a deep learning system 406. Deep learning system 406 may be implemented as a neural network that includes multiple layers, each layer producing output for a next layer. Input layer 412 receives the above-mentioned tags, produced by topic modelling 402, and eye gaze information 404. Input layer 412 includes multiple neurons, or nodes, which appear as ovals in FIG. 4. Output of the nodes of input layer 412 are provided to nodes of a first layer of hidden layers for processing. Outputs of nodes of each layer of the hidden layer are provided to nodes of a next layer of hidden layers and are eventually provided to nodes of predictive output units, which produce a model such as, for example, SIM 408. SIM 408 may include a table of words or phrases 410 related to different topics and having corresponding weights, which are based on a maximum likelihood estimate that a topic is a specific topic based on a particular word or phrase.

Deep learning system 406 also may learn topics of read paragraphs and unread paragraphs based on topic modelling 402 and eye gaze information 404. For example, deep learning system 406 may use duration data included in eye gaze information 404 to determine whether a user gazed at respective paragraphs for at least a minimum threshold of time. Deep learning system 406 may consider paragraphs with corresponding duration data that is greater than or equal to a minimum threshold of time as read and paragraphs with corresponding duration data that is less than the minimum threshold of time as unread. Deep learning system 406 may consider topics of paragraphs that are considered to be read as topics of interest. In some embodiments, one or more additional thresholds of time may be used by deep learning system 406 to learn which paragraphs are read, which paragraphs are unread, and which paragraphs are skimmed, or lightly read.

The produced model may also include information for predictions of where on a display a user is most likely to look as determined by deep learning system 406 based on eye gaze information 404, including duration of eye gazes, and further based on topic modelling 402 of content included in regions of the display at which a user gazes for at least the above-mentioned minimum threshold of time such that the content may be considered to have been read.

In some embodiments, SIM 408, itself, may be implemented as a neural network. In such embodiments, SIM 408 may check paragraphs of an item of textual content for a presence of words and phrases such as, for example, words and phrases included in table 410. SIM 408 also may predict whether particular display areas will be viewed based on learned viewed display areas by deep learning system 406. SIM 408 also may use weights associated with the words and phrases of table 410 to predict a topic of each paragraph.

SIM 408 may be asymptotic in some embodiments. That is, additional training data may be created and used to improve an accuracy of predictions based on SIM 408. However, there is a limit to which a model such as SIM 408 may be improved. Once that limit has been reached, no further training should be performed. Test data may be created to test the accuracy of SIM 408 to determine whether additional training could improve the accuracy.

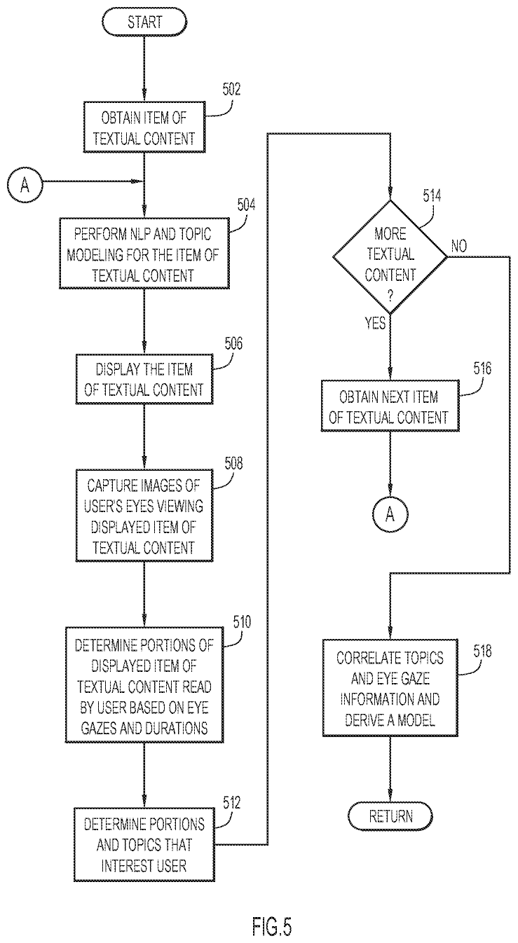

FIG. 5 is a flowchart that illustrates an example process for generating tags based on topic modeling 402 and collecting eye gaze information 404. The process may begin by obtaining an item of textual content (act 502). The item of textual content may be obtained from a website such as, for example, a social media website or a blog, or other textual content source.

Natural language processing and topic modeling of units of textual content within the item of textual content may be performed and the units of textual content may be tagged as previously described (act 504). The units of textual content may be paragraphs of textual content, specific portions of textual content including, but not limited to, an abstract, a conclusion and a main body, or other unit of textual content.

The item of textual content may then be displayed on a display screen of a computer device (act 506). An image capturing device may capture images of a user's eyes viewing regions of the display screen that are displaying at least portions of the item of textual content (act 508). Portions of the displayed item of textual content may be determined as being read or unread based on mapping regions of the displayed content gazed upon by the user and durations of corresponding gazes to specific displayed units of the item of textual content (act 510). This information may be used to determine portions of the item of textual content of interest and topics of interest to the user (act 512).

A determination may then be made whether additional items of textual content are to be obtained (act 514). If so, a next item of textual content may be obtained and acts 504-514 may again be performed. If there are no additional items of textual content to obtain, then tags corresponding to topics of units of the items of textual content and corresponding eye gaze information may be correlated by a deep learning system, as previously described, to derive a model such as, for example, a SIM (act 518). This process may then be completed.

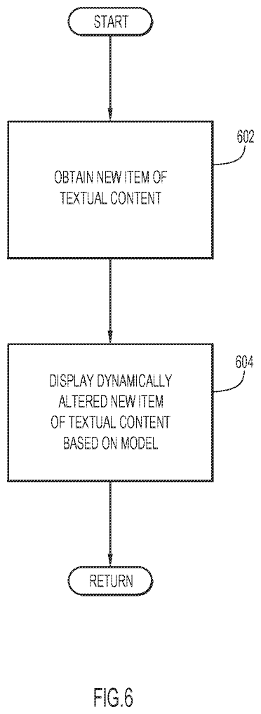

After deriving the model, an item of new textual content may be obtained via a network such as, for example, the Internet or other source (FIG. 6; act 602). The model may be applied to the units of the new item of textual content, which may be dynamically altered and displayed as previously described (act 604).

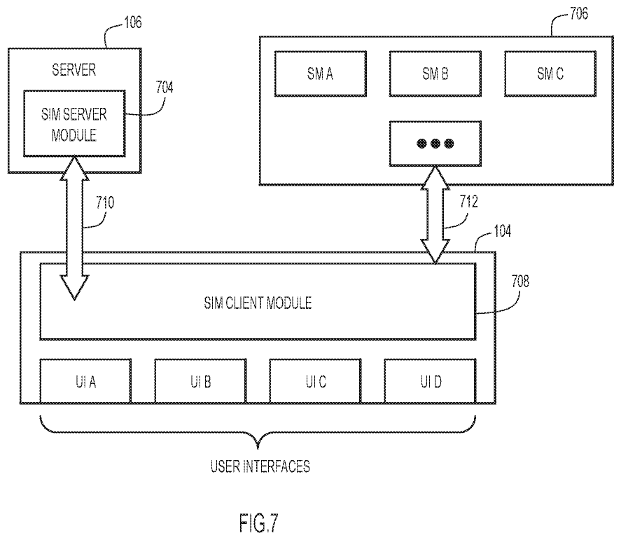

FIG. 7 illustrates one example embodiment of the invention. SIM client module 708 may be included within client device 104. Client device 104 may include a number of user interfaces such as, for example, a user interface for a personal computer, a user interface for a tablet computer, a user interface for a smart phone, and/or a user interface for another type of device.

Server 106 may include a SIM server module 704. SIM client module 708 and SIM server module 704 may communicate with each other via a network. Social media platforms 506 may include social media platform A (SM A), social media platform B (SM B), social media platform C (SM C), as well as other social media platforms.

SIM client module 708 may collect topic information regarding paragraphs of items of textual content, obtained from social media platforms 706 such as, for example, social Wikis, blogs, or other sources, and user focus information indicating specific parts of an item of textual content on which a user focuses such as, for example, an abstract or a conclusion, as well as one or more locations of a display on which the user gazes corresponding to items of displayed textual content. SIM client module 708 also may determine whether paragraphs or other units of textual content include topics of interest to a user and may display an altered version of the item of textual content in which paragraphs that are predicted to remain unread may be removed. Alternatively the displayed altered version of the item of textual content may be re-factored such that paragraphs including topics of interest and/or specific portions of interest may be displayed before unread paragraphs and/or unread specific portions of the item textual content. In some embodiments, paragraphs having topics of interest and/or specific portions of interest may be displayed at portions of a display screen at which the user is likely to look.

SIM server module 704 may collect topic information and eye gaze information from SIM clients modules 708 of individual users' client devices 104 and may derive SIM 408 based thereon.

Other embodiments may include a standalone client device 104, which performs topic modelling of paragraphs of displayed items of textual content, collects eye gaze information while a user reads the displayed items of textual content, derives SIM 408 and interprets and displays altered items of textual content, as previously discussed, wherein SIM 408 is based on an individual user's topics of interest and eye gaze information. By providing a subset of items of textual content for presentation to a user, less memory and processing resources are consumed. As a result, client device 104 provides faster processing and displaying of paragraphs of topics of interest.

Another embodiment may reside completely within server 106. A subset of items of textual content maybe stored within a stateful session allowing for smaller subsets of memory for use during retrieval of items of textual content, thereby providing faster processing of items of textual content from server 106.

Embodiments of the invention further may include a database in which a mapping model for mapping topics to a user's interest may be bound to the database. For example, topics of interest and topics of non-interest may be written to respective specific database tables based on an ID of the user. Textual content may be refactored based on database JOIN operations.

It will be appreciated that the embodiments described above and illustrated in the drawings represent only a few of the many ways of implementing the various embodiments of the invention.

The environment of the present invention embodiments may include any number of computer or other processing systems such as client or end-user systems, server systems, etc. and databases or other repositories arranged in any desired fashion, where the present invention embodiments may be applied to any desired type of computing environment such as cloud computing, client-server, network computing, mainframe, etc. The computer or other processing systems employed by the present invention embodiments may be implemented by any number of any personal or other type of computer or processing system such as desktop, laptop, PDA, mobile devices, etc., and may include any commercially available operating system and any combination of commercially available and custom software such as, for example, browser software, communications software, and server software. These systems may include any types of monitors and input devices such as keyboard, mouse, voice recognition, etc. to enter and/or view information.

It is to be understood that the software of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium such as a LAN, WAN, Intranet, Internet, hardwire, modem connection, wireless, etc. For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments may be available on a non-transitory computer useable medium, such as magnetic or optical media, magneto-optic media, floppy diskettes, CD-ROM, DVD, memory devices, etc., of a stationary or portable program product apparatus or device for use with systems connected by a network or other communications medium.

The communication network may be implemented by any number of any type of communications network such as a LAN, WAN, Internet, Intranet, VPN, etc.. The computer or other processing systems of the present invention embodiments may include any conventional or other communications devices to communicate over the network via any conventional or other protocols. The computer or other processing systems may utilize any type of connection, such as a wired, wireless, etc., for access to the network. Local communication media may be implemented by any suitable communication media such as a local area network (LAN), hardwire, wireless link, Intranet, etc.

The system may employ any number of any conventional or other databases, data stores or storage structures, such as files, databases, data structures, data or other repositories, etc., to store information. The database system may be implemented by any number of any conventional or other databases, data stores or storage structures, such as files, databases, data structures, data or other repositories, etc., to store information. The database system may be included within or coupled to the server and/or client systems. The database systems and/or storage structures may be remote from or local to the computer or other processing systems, and may store any desired data.

The present invention embodiments may employ any number of any type of user interface, such as a Graphical User Interface (GUI), command-line, prompt, etc., for obtaining or providing information, where the interface may include any information arranged in any fashion. The interface may include any number of any types of input or actuation mechanisms, such as buttons, icons, fields, boxes, links, etc., disposed at any locations to enter/display information and initiate desired actions via any suitable input devices such as a mouse, keyboard, etc. The interface screens may include any suitable actuators, such as links, tabs, etc., to navigate between the screens in any fashion.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media, such as light pulses passing through a fiber-optic cable or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for altering textual content based on machine learned topics, the method comprising:
performing for each of a plurality of items of textual content:
tagging, by at least one processing device, each content portion of a respective item of textual content according to determined topics, keywords and phrases, and
collecting, by at least one processing device, data regarding viewed regions of a display screen displaying at least a portion of the respective item;
deriving, by at least one processing device, a model for predicting portions of textual content of interest based on the collected data regarding the viewed regions of the display screen and the tagging; and
altering a new item of textual content to provide portions of interest based on the model.

2. The method of claim 1, wherein:
the data regarding the viewed regions of the display screen include a time duration during which each of the viewed regions was viewed, and
the performing for each of the plurality of items of textual content further comprises:
tagging, as unread portions, portions corresponding to unviewed regions and portions corresponding to viewed regions having corresponding time durations that are less than a threshold time.

3. The method of claim 1, further comprising:
predicting which portions of the new item of textual content will be unread based on the model; and
deleting the predicted unread portions of the new item of textual content to provide the portions of interest.

4. The method of claim 1, wherein:
the performing for each of the plurality of items of textual content further comprises:
inferring specific portions of the respective item of textual content based on boundary headings included therein, and
tagging the specific portions to indicate the inferred specific portion; and
the method further comprises predicting a position of the specific portions within the new item of textual content based on the model.

5. The method of claim 4, further comprising:
predicting which of the specific portions of the new item of textual content are specific portions of interest based on the model; and
refactoring the new item of textual content to produce an altered version of the new item of textual content such that the specific portions of interest are positioned closer to a top of the altered version of the new item of textual content than other specific portions.

6. The method of claim 1, further comprising:
predicting which paragraphs of the new item of textual content are paragraphs of interest based on the model; and
refactoring the new item of textual content to produce an altered version of the new item of textual content such that the predicted paragraphs of interest, based on the model, are positioned closer to a top of the altered version than other paragraphs.

7. The method of claim 1, further comprising:
performing, on each of the content portions of the respective item of the plurality of items of textual content:
lexically analyzing the each of the content portions;
syntactically analyzing the each of the content portions;
pragmatically analyzing the each of the content portions; and
topic modelling the each of the content portions.

8. A system for altering textual content based on machine learned topics, the system comprising:
at least one processor; and
one or more memories connected to each of the at least one processor, wherein the at least one processor is configured to perform:
performing for each of a plurality of items of textual content:
tagging each content portion of a respective item of textual content according to determined topics, keywords and phrases, and
collecting data regarding viewed regions of a display screen displaying at least a portion of the respective item;
deriving a model for predicting portions of textual content of interest based on the collected data regarding the viewed regions of the display screen and the tagging; and
altering a new item of textual content to provide portions of interest based on the model.

9. The system of claim 8, wherein:
the data regarding the viewed regions of the display screen include a time duration during which each of the viewed regions was viewed, and
the performing for each of the plurality of items of textual content further comprises:
tagging, as unread portions, portions corresponding to unviewed regions and portions corresponding to viewed regions having corresponding time durations that are less than a threshold time.

10. The system of claim 8, wherein the at least one processor is further configured to perform:
predicting which portions of the new item of textual content will be unread based on the model; and
deleting the predicted unread portions of the new item of textual content to provide the portions of interest.

11. The system of claim 8, wherein:
the performing for each of the plurality of items of textual content further comprises:
inferring specific portions of the respective item of textual content based on boundary headings included therein, and
tagging the specific portions to indicate the inferred specific portion; and
the at least one processor is further configured to predict a position of the specific portions within the new item of textual content based on the model.

12. The system of claim 11, wherein the at least one processor is further configured to perform:
predicting which of the specific portions of the new item of textual content are specific portions of interest based on the model; and
refactoring the new item of textual content to produce an altered version of the new item of textual content such that the specific portions of interest are positioned closer to a top of the altered version of the new item of textual content than other specific portions.

13. The system of claim 8, wherein the at least one processor is further configured to perform:
predicting which paragraphs of the new item of textual content are paragraphs of interest based on the model; and
refactoring the new item of textual content to produce an altered version of the new item of textual content such that the predicted paragraphs of interest, based on the model, are positioned closer to a top of the altered version than other paragraphs.

14. The system of claim 8, wherein the at least one processor is further configured to perform on each of the content portions of the respective item of the plurality of items of textual content:
lexically analyzing the each of the content portions;
syntactically analyzing the each of the content portions;
pragmatically analyzing the each of the content portions; and
topic modelling the each of the content portions.

15. A computer program product comprising at least one computer readable storage medium having computer readable program code embodied therewith for execution on at least one processor of a computer device, the computer readable program code being configured to be executed by the at least one processor to perform:
performing for each of a plurality of items of textual content:
tagging each content portion of a respective item of textual content according to determined topics, keywords and phrases, and
collecting data regarding viewed regions of a display screen displaying at least the portion of the respective item;
deriving a model for predicting portions of textual content of interest based on the collected data regarding the viewed regions of the display screen and the tagging;
altering a new item of textual content to provide portions of interest based on the model.

16. The computer program product of claim 15, wherein:
the data regarding the viewed regions of the display screen include a time duration during which each of the viewed regions was viewed, and
the performing for each of the plurality of items of textual content further comprises:
tagging, as unread portions, portions corresponding to unviewed regions and portions corresponding to viewed regions having corresponding time durations that are less than a threshold time.

17. The computer program product of claim 15, wherein the computer readable program code is further configured to be executed by the at least one processor to perform:
predicting which portions of the new item of textual content will be unread based on the model; and
deleting the predicted unread portions of the new item of textual content to provide the portions of interest.

18. The computer program product of claim 15, wherein the computer readable program code is further configured to be executed by the at least one processor to perform:
predicting which paragraphs of the new item of textual content are paragraphs of interest based on the model; and
refactoring the new item of textual content to produce an altered version of the new item of textual content such that the predicted paragraphs of interest, based on the model, are positioned in a region of the display screen at which a user is predicted to look.

19. The computer program product of claim 15, wherein the model is a neural network model.

20. The computer program product of claim 15, wherein the model is asymptotic.
